(19) United States
(12) Patent Application Publication
(10) Pub. No.: US 2023/0284569 A1
(43) Pub. Date: Sep. 14, 2023

(54) SEEDLING STARTER TRAY CONVENIENT FOR TRANSPLANTING

(71) Applicant: Hangzhou Shide Technology Co., Ltd., Hangzhou (CN)

(72) Inventor: Botu DING, Hangzhou (CN)

(73) Assignee: Hangzhou Shide Technology Co., Ltd., Hangzhou (CN)

(21) Appl. No.: 17/824,939

(22) Filed: May 26, 2022

(30) Foreign Application Priority Data
Mar. 8, 2022 (CN) 202220490843.4

(51) Int. Cl. A01G 9/029

(52) U.S. Cl. CPC A01G 9/0295

(57) ABSTRACT

A seedling starter tray convenient for transplanting includes a tray body and seedling transfer holders. The tray body includes a plurality of connected seedling culture cells arrayed longitudinally and horizontally. The seedling transfer holder in the seedling culture cell is similar to a bottom of the seedling culture cell and entirely fits the bottom of the seedling culture cell. After seedling culture is finished, a lumpy substrate wrapping a seedling needs to be transferred. Particularly, the seedling transfer holder is pushed out of the seedling culture cell with fingers or auxiliary tools via the through hole in the bottom of the seedling culture cell, and then is removed to perform transplanting of the seedling. Through the seedling starter tray, the seedling can be prevented from being damaged when transplanted, thereby improving the survival rate of the transplanted seedling.

### CROSS REFERENCE TO THE RELATED APPLICATIONS

This application is based upon and claims priority to Chinese Patent Application No. 202220490843.4, filed on Mar. 8, 2022, the entire contents of which are incorporated herein by reference.

### TECHNICAL FIELD

The present invention relates to the field of tools for seedling culture, in particular to a seedling starter tray convenient for transplanting.

### BACKGROUND

During the cultivation of seedlings of garden plants, seedling starter trays are typically adopted to culture the seedlings. However, when the seedlings need to be transplanted, lumpy substrates cannot be taken out easily because they are deeply embedded into the seedling starter trays and firmly attached to the internal walls of the seedling starter trays. If the lumpy substrates wrapping the seedlings are forcedly taken out, the young stems of the seedlings may be broken, and even the roots of the seedlings may be separated from the lumpy substrates. In this case, the roots of the seedlings are exposed in air and are easily damaged, resulting in a low survival rate of transplanted seedlings.

To solve the above problems, it is necessary to develop a seedling starter tray convenient for transplanting seedlings to prevent the seedlings from being damaged during transplanting, thus improving the survival rate of the transplanted seedlings.

### SUMMARY

The objective of the present invention is to solve the problems of the prior art by providing a seedling starter tray convenient for transplanting seedlings. The seedling starter tray can prevent seedlings from being damaged during transplanting, thus improving the survival rate of transplanted seedlings.

The present invention adopts the following technical solution.

The present invention provides a seedling starter tray convenient for transplanting. The seedling starter tray includes a tray body and seedling transfer holders. The tray body includes a plurality of connected seedling culture cells arrayed longitudinally and horizontally and a through hole through which the seedling transfer holder can be pushed out is formed in a bottom of the seedling culture cell. The seedling transfer holder in the seedling culture cell is detachably fixed to the bottom of the seedling culture cell and located above the through hole, and thus can be pushed upwards via the through hole to be separated from the seedling culture cell. The seedling transfer holder is matched with the bottom of the seedling culture cell in size, so as to fit and cover the bottom of the seedling culture cell.

Preferably, the seedling culture cell is shaped as a trough open upwards and having a cross section gradually reduced from top to bottom, so as to facilitate seedling culture.

Preferably, a water channel for equalizing water is formed between the tops of adjacent two of the seedling culture cells.

Preferably, a vent and drain hole is formed in a bottom of the seedling transfer holder.

Further, the vent and drain hole is smaller than the through hole in size.

Further, the vent and drain hole is located at a center of the bottom of the seedling transfer holder.

Preferably, the seedling transfer holder is shaped as a saucer which has a flat bottom and a periphery extending upwards.

Preferably, the bottom of the seedling transfer holder is attached and fixed to the bottom in the seedling culture cell.

Preferably, the bottom of the seedling transfer holder is larger than the through hole in size.

Compared with the prior art, the present invention has the following beneficial effects:

the seedling transfer holder similar to the bottom of the seedling culture cell in size is arranged at the bottom in the seedling culture cell; when the seedling needs to be transplanted, the seedling transfer holder together with the seedling is pushed upwards via the through hole in the bottom of the seedling culture cell to be separated from the seedling culture cell. In this way, the seedling can be prevented from being damaged, thereby improving the survival rate of the transplanted seedling.

### BRIEF DESCRIPTION OF THE DRAWINGS

FIG. 1 is a schematic view (top view) of a tray body of the present invention;

FIG. 2 is a schematic view (bottom view) of the tray body of the present invention;

FIG. 3 is a schematic view of a seedling transfer holder of the present invention;

FIG. 4 is a schematic view showing how to put the seedling transfer holder into a seedling culture cell of the present invention; and

FIG. 5 is a schematic view showing how to push the seedling transfer holder out of the seedling culture cell of the present invention.

### REFERENCE NUMERALS

1. tray body, 2. seedling culture cell, 3. water channel, 4. through hole, 5. seedling transfer holder, 6. vent and drain hole.

### DETAILED DESCRIPTION OF THE EMBODIMENTS

The present invention is further described below with reference to the drawings and implementations. All the implementations of the present invention can be correspondingly combined on the premise that their technical features are not conflicted.

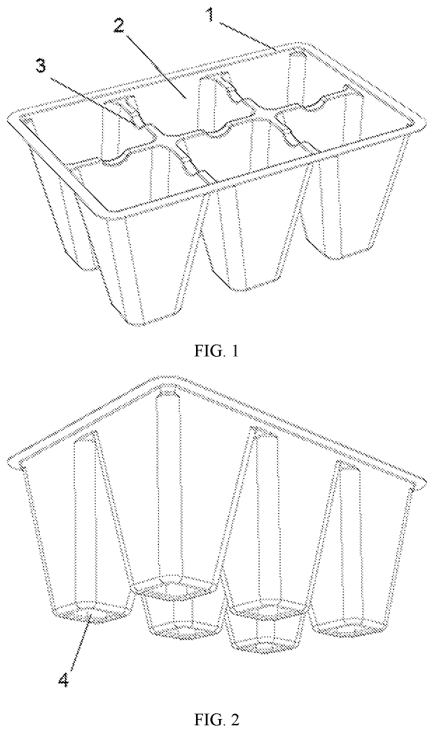

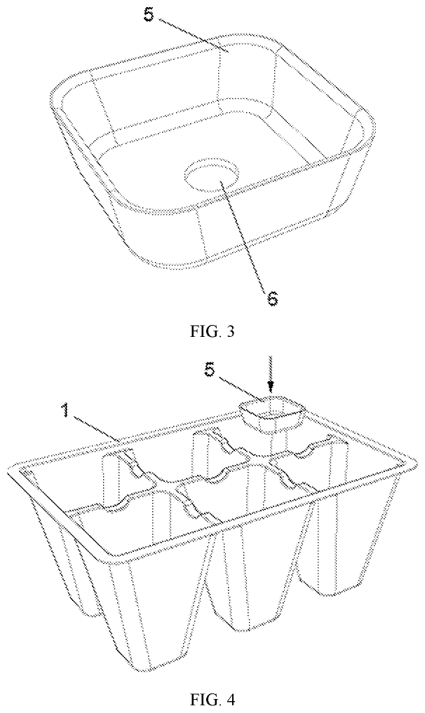

As shown in FIG. 1 to FIG. 3, the present invention provides a seedling starter tray convenient for transplanting. The seedling starter tray mainly includes a tray body 1 and seedling transfer holders 5. The tray body 1 includes a plurality of connected seedling culture cells 2 arrayed longitudinally and horizontally. As shown in FIG. 1, six connected seedling culture cells 2 are arrayed by two rows and three columns. In actual use, the number, structure, and connection mode of the seedling culture cells 2 in the tray body 1 can be adjusted to meet different requirements for seedling culture.

The seedling transfer holder 5 in the seedling culture cell 2 is detachably fixed to the bottom of the seedling culture cell 2. The seedling transfer holder 5 is similar to the seedling culture cell in structure and size, so as to fit and cover the bottom of the seedling culture cell 2. In this way, a lumpy substrate and a seed which are added to the bottom of the seedling culture cell 2 from a top of the seedling culture cell 2 can completely fall onto the seedling transfer holder. The seedling transfer holder 5 can be shaped as a saucer which has a flat bottom and a periphery extending upwards from the flat bottom, so as to support a seedling. A through hole 4 is formed at the bottom of the seedling culture cell 2 and positioned below the seedling transfer holder 5. When the seedling needs to be transplanted, the seedling transfer holder 5 is pushed upwards by a force applied through the through hole 4 from the bottom of the seedling culture cell 2 to be separated from the seedling culture cell 2.

In actual use, the seedling culture cell 2 is formed to be gradually narrowed from top to bottom; that is, the seedling culture cell 2 is shaped as a trough open upwards and having a cross section gradually reduced from top to bottom, so as to facilitate seedling culture. The cross section of the seedling culture cell 2 may be rectangular or made into other shapes as required. A water channel 3 for equalizing water is formed between the tops of adjacent two of the seedling culture cells 2. If different amounts of water are added to the adjacent two of the seedling culture cells 2, the water flows from the seedling culture cell 2 with a high water level to the seedling culture cell 2 with a low water level via the corresponding water channel 3. In this way, the water can be evenly distributed for the second time, so that the water is fully utilized.

To prevent the seed from becoming rotten due to excessive water poured into the seedling culture cell 2, a vent and drain hole 6 is formed at a center of the bottom of the seedling transfer holder 5. The vent and drain hole 6 is smaller in size than the through hole 4, and the bottom of the seedling transfer holder 5 is larger in size than the through hole 4, so that the seedling transfer holder 5 can be easily pushed out without damaging the seed and lumpy substrate in the seedling transfer holder 5.

An application method of the seedling starter tray is particularly as follows:

As shown in FIG. 4, at the beginning of the seedling culture, the seedling transfer holder 5 is respectively put into the seedling culture cell 2 in the tray body 1 first, and then the lumpy substrate and the seed are added to the seedling culture cell 2 to start the seedling culture. In the process of the seedling culture, it is necessary to frequently water the lumpy substrate to provide sufficient water for the seed. The water needed by each seedling culture cell 2 in the tray body 1 can be equalized by the water channel 3 between the adjacent two of the seedling culture cells 2. The excessive water can flow out of the tray body 1 via the vent and drain hole 6 in the seedling transfer holder 5 and the through hole 4 in the seedling culture cell 2, so that the seed can be prevented from becoming rotten.

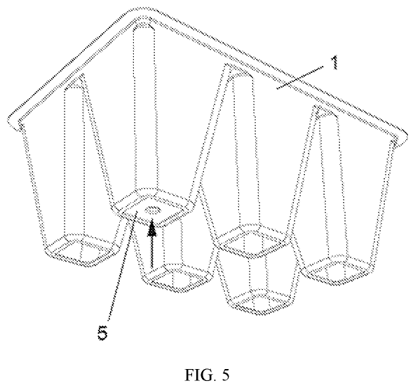

As shown in FIG. 5, after the seedling culture is finished, the lumpy substrate wrapping the seedling needs to be transferred. Particularly, the seedling transfer holder 5 is pushed out of the seedling culture cell 2 with fingers or auxiliary tools via the through hole 4 in the bottom of the seedling culture cell 2, and then is removed to perform transplanting of the seedling.

According to the present invention, the seedling can be prevented from being damaged when transplanted, thereby improving the survival rate of the transplanted seedling.

The above described are merely preferred embodiments of the present invention, and are not intended to limit the present invention. Various changes and transformations can be made by persons of ordinary skill in the relevant technical field without departing from the spirit and scope of the present invention. All technical solutions obtained by means of equivalent substitution or equivalent transformation should fall within the protection scope of the present invention.

What is claimed is:

1. A seedling starter tray convenient for transplanting, comprising a tray body and seedling transfer holders, wherein
the tray body comprises a plurality of seedling culture cells, and the plurality of seedling culture cells are connected and arrayed longitudinally and horizontally;
a through hole is formed in a bottom of each of the seedling culture cells; the seedling transfer holders are detachably fixed to the bottom of each of the seedling culture cells and located above the through holes, the seedling transfer holders are configured to be pushed upwards via the through hole to be separated from the seedling culture cell; and
the seedling transfer holders are matched with the bottoms of the seedling culture cells in size, and fit and cover the bottoms of the seedling culture cells.

2. The seedling starter tray according to claim 1, wherein each of the seedling culture cells is shaped as a trough open upwards and having a cross section gradually reduced from top to bottom to facilitate seedling culture.

3. The seedling starter tray according to claim 1, wherein a water channel for equalizing water is formed between tops of adjacent two of the seedling culture cells.

4. The seedling starter tray according to claim 1, wherein a vent and drain hole is formed at a bottom of each of the seedling transfer holders.

5. The seedling starter tray according to claim 4, wherein the vent and drain hole is smaller than the through hole in size.

6. The seedling starter tray according to claim 4, wherein the vent and drain hole is located at a center of the bottom of each of the seedling transfer holders.

7. The seedling starter tray according to claim 1, wherein each of the seedling transfer holders is shaped as a saucer, and the saucer has a flat bottom and a periphery extending upwards.

8. The seedling starter tray according to claim 1, wherein a bottom of each of the seedling transfer holders is attached and fixed to the bottom of each of the seedling culture cells.

9. The seedling starter tray according to claim 1, wherein a bottom of each of the seedling transfer holders is larger than the through hole in size.
